(19) United States
(12) Patent Application Publication
(10) Pub. No.: US 2002/0060257 A1
(43) Pub. Date: May 23, 2002

(54) FUEL INJECTION VALVE

(76) Inventors: BO YUAN, DITZINGEN (DE); GUNTHER DANTES, EBERDINGEN (DE); JORG HEYSE, BESIGHEIM (DE)

Correspondence Address: KENYON & KENYON, ONE BROADWAY, NEW YORK, NY, 10004, US

(21) Appl. No.: 09/463,365

(22) PCT Filed: Feb. 5, 1999
(86) PCT No.: PCT/DE99/00300

(30) Foreign Application Priority Data
May 22, 1998 (DE) 198 22 896.1

(51) Int. Cl. F02M 51/00

(52) U.S. Cl. 239/585.1

(57) ABSTRACT

The fuel injection valve described is characterized in that a perforated disk (23) is arranged downstream from a valve seat surface (29) of a valve seat body (16), the perforated disk (23) being held on the valve seat body (16) by a flat, disk-shaped perforated disk carrier (21). The perforated disk (23) has a full passage for a fluid and at least one inlet opening in a bottom functional layer. The perforated disk carrier (21) has a through opening (20), which is directly surrounded by an edge area (35), which is provided with formations (38) that reduce the spring constant of the perforated disk carrier (21).

### BACKGROUND OF THE INVENTION

The invention is based on a fuel injection valve according to the definition of the species of the main claim.

German Offenlegungsschrift 196 39 506 describes a fuel injection valve, which has a valve seat body with a valve seat surface, and a perforated disk carrier attached to the valve seat body. The perforated disk carrier is used to hold a multilayer perforated disk, manufactured by multilayer electroplating by squeezing. The perforated disk carrier is designed as a flat disk for this purpose, has a pot-shaped structure overall and a uniform thickness over its entire extension. The perforated disk carrier is attached to the valve seat body with the help of an annular weld. However, when the perforated disk carrier is welded on, the squeezing force of the perforated disk carrier with which the perforated disk is pressed against the valve seat body is reduced due to the thermal relaxation of the prestressed material of the perforated disk carrier. In addition, in the area of the weld, an air gap remains between the valve seat body and the perforated disk carrier, which reduces the quality of the weld and the squeezing effect.

Perforated disk carriers, support disks, support rings or lock nuts for perforated disks of injection valves or injection nozzles are known, for example, from British Patent 201,556, German Offenlegungsschrift 41 23 692, German Offenlegungsschrift 44 46 241 and German Offenlegungsschrift 195 27 626, in which, however, no indication is given for improving the squeezing action by varying the spring constant.

### SUMMARY OF THE INVENTION

The fuel injection valve according to the present invention with the characterizing features of claim 1 has the advantage that a particularly high quality of the joint of the perforated disk carrier on the valve seat body is achieved, which in turn results in a very good holding effect of the perforated disk carrier on the perforated disk being achieved, which barely affects or does not at all affect the attachment of the perforated disk carrier.

For this purpose, the perforated disk carrier is provided with formations reducing the spring constant of the perforated disk carrier in an edge area surrounding the through hole, which serves to directly hold (squeeze) the perforated disk. Taking into consideration the tolerances, it is ensured, when determining the limiting diameter for the specially shaped edge area, that the joint (weld) is always applied outside the edge area of the perforated disk carrier.

The spring constant of the perforated disk carrier is reduced in a controlled manner by reducing the thickness or by slotting, so that when the perforated disk carrier is pressed onto the valve seat body prior to welding, this less rigid edge area is bent. In the weld area, prestress is thus reduced compared to related art designs. In addition, in the area of the weld to be applied, the perforated disk carrier already rests on the bottom face of the valve seat body basically without an air gap, which reduces the thermal relaxation in the weld area. Therefore the squeezing action of the perforated disk carrier on the perforated disk is well preserved even after welding.

The measures described in the subclaims allow further improvements on and refinements of the fuel injection valve presented in the main claim.

In a particularly advantageous manner, the formations in the edge area of the through hole are formed by reducing the thickness or by slotting. The thickness of the perforated disk carrier is reduced by forming an annular shoulder from either the top face or the bottom face by stamping.

It is particularly advantageous to use perforated disks that are manufactured by electroplating and made of one piece, the individual functional layers being built up in consecutive electrodeposition steps. After completion of the metal deposition, the perforated disk is formed of a single piece; therefore, no time-consuming and cost-intensive process steps are required for attaching the individual nozzle laminae.

It is particularly advantageous to design the perforated disks in the form of S-type disks (S-shaped flow pattern within the disk) so that unusual bizarre jet shapes can be obtained. In an S-type disk there is optimally an offset between the inlet openings and outlet openings. The unusual jet shapes that can be obtained allow the specified geometries to be optimally matched, for example, to the different intake manifold cross sections of internal combustion engines. The result is a shape-matched utilization of the available cross sections for homogeneously distributed exhaust gas-reducing mixture delivery, while film deposits on the walls of the intake manifold, which would negatively affect the exhaust gases, are avoided.

### BRIEF DESCRIPTION OF THE DRAWINGS

Embodiments of the invention are schematically illustrated in the drawing and elucidated in detail in the description that follows.

FIG. 1 shows a partially illustrated injection valve having a first attachment, according to the present invention, of a perforated disk to a perforated disk carrier;

FIG. 2 shows a second exemplary embodiment of such an attachment at the valve end;

FIG. 3 shows a top view of an edge area of the perforated disk of FIG. 2 provided with an anti-turning feature;

FIG. 4 shows a third exemplary embodiment of a perforated disk having a perforated disk carrier at the valve end;

FIG. 5 shows a fourth exemplary embodiment of such an attachment at the valve end;

FIG. 6 shows a detail of FIG. 5 with a perforated disk provided with an anti-turning feature achieved by caulking;

FIG. 7 shows another perforated disk carrier in cross section, and

FIG. 8 shows the top view of the perforated disk carrier according to FIG. 7.

### DETAILED DESCRIPTION

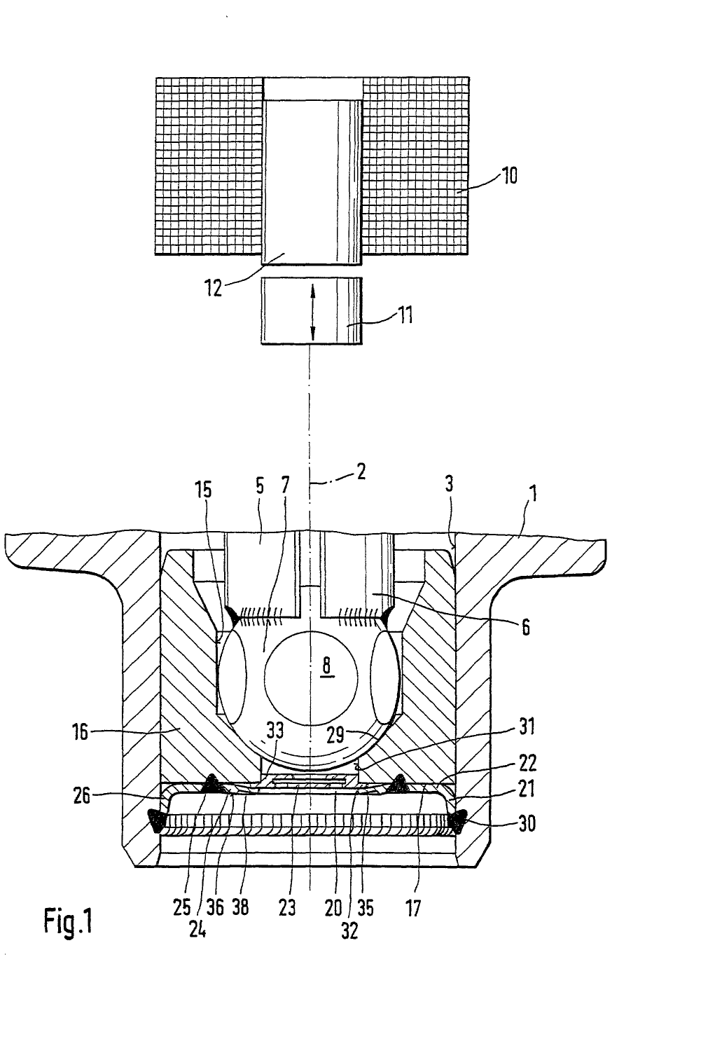

FIG. 1 partially shows an embodiment of a valve in the form of an injection valve for fuel injection systems of compressed mixture, externally ignited internal combustion engines. The injection valve has a tubular valve seat carrier 1, having a longitudinal hole 3 running concentrically to a longitudinal valve axis 2. A valve needle 5, which may be tubular, for example, and has spherical valve closing body 7 at its downstream end 6 on whose periphery five flats 8, for example, are provided for the passage of fuel, is arranged in longitudinal hole 3.

The injection valve is actuated in the known manner, for example, electromagnetically. A schematically indicated electromagnetic circuit having a magnet coil 10, an armature 11, and a core 12 is used to move valve needle 5 axially and thus to open the valve against the elastic force of a restoring spring, which is not illustrated, and to close it. Armature 11 is connected to the end of valve needle 5 facing away from valve closing body 7, for example, through a weld produced by a laser and aligned with core 12.

A guide hole 15 of a valve seat body 16, which is snugly installed at the downstream end of valve seat carrier 1, facing away from core 12, in longitudinal hole 3 running concentrically to longitudinal valve axis 2 by welding, is used to guide valve closing body 7 during its axial movement. Bottom face 17 of valve seat body 16, facing away from valve closing body 7, is firmly and concentrically attached to a perforated disk carrier 21, which may have a pot-shaped design, for example, and is used as a support, so at least an outer annular area 22 of perforated disk carrier 21 directly rests on valve seat body 16. Perforated disk carrier 21 has a shape that is similar to that of the known pot-shaped perforated spray disk, a central area of perforated disk carrier 12 being provided with a through hole 20 that has no delivery function.

A perforated disk 23, which is designed as a one-piece but multilayered electroplated perforated spray disk, is arranged upstream from through hole 20 so that it completely covers through hole 20. Perforated disk carrier 21 has an internal bottom part 24 and an outside support edge 26. Support edge 26 extends in the axial direction facing away from valve seat body 16 and is conically bent outward up to its end. Bottom part 24 is formed by outer annular area 22 and central through hole 20.

Valve seat body 16 and perforated disk carrier 21 are connected via a peripheral continuous first weld 25, produced by a laser. With this type of assembly, the danger of undesirable deformation of perforated disk carrier 21 in its central area having through hole 20 and perforated disk 23 arranged upstream is avoided. The area of support edge 26 of perforated disk carrier 21 is also attached to the wall of longitudinal hole 3 of valve seat carrier 1, for example, by a peripheral and continuous second weld 30.

Perforated disk 23, which can be squeezed in the area of through hole 20 within circular weld 25 between perforated disk carrier 21 and valve seat body 16 is designed to be stepped, for example. An upper perforated disk area 33, which has a smaller diameter than a base area 32, protrudes into and snugly fits in a cylindrical outlet opening 31 of valve seat body 16, which is arranged immediately downstream from a valve seat surface 29. For this area of the perforated disk 33 and outlet opening 31, press fitting can also be provided. Base area 32 of perforated disk 23, which protrudes radially outward beyond perforated disk area 33 and can thus be squeezed in, rests on bottom face 17 of valve seat body 16 so that at this point bottom part 24 of perforated disk carrier 21 is located at a small distance from face 17. While perforated disk area 33 includes two functional layers, for example, a middle layer and an upper layer of perforated disk 23, a single bottom functional layer forms base area 32. A functional layer should have a constant opening contour over its axial extension.

According to the present invention, perforated disk carrier 21 has a reduced thickness in the edge area of central through hole 20, which means that perforated disk carrier 21 has in at least part of edge area 35 of through hole 20 a smaller thickness than over the rest of its extension (annular area 22, support edge 26). In the embodiment illustrated in FIG. 1, the area within weld 25 of perforated disk carrier 21 up to through hole 20 has a reduced thickness so that edge area 35 is only half as thick as the rest of perforated disk carrier 21. A shoulder 38 is provided on bottom face 36 of perforated disk carrier 21 facing away from face 17 of valve seat body 16 in order to form thinner edge area 35. Edge area 35 that has a smaller thickness is used directly for squeezing perforated disk 23. The contour of edge area 35 is obtained by stamping, for example.

Taking into account the tolerances, it is ensured, when the limiting diameter is determined for the thinner edge area 35, that weld 25 is always applied in the thicker area of perforated disk carrier 21. In edge area 35, the spring constant of perforated disk carrier 21 is reduced in a controlled manner by reducing the thickness so that when perforated disk carrier 21 is pressed onto valve seat body 16 prior to being welded on, mainly this thinner edge area 35 is bent. In the area of weld 25, the prestress is thus reduced compared to the known design having a constant thickness. In addition, perforated disk carrier 21 rests on bottom face 17 of valve seat body 16 in the area of weld 25 to be applied basically without an air gap, which reduces the thermal relaxation in weld area 25. Thus the squeezing effect on perforated disk 23 is preserved well even after welding.

The insertion depth of the valve seat part composed of valve seat body 16, pot-shaped perforated disk carrier 21 and perforated disk 23 into longitudinal hole 3 determines the lift of valve needle 5, since one end position of valve needle 5 when magnet coil 10 is not excited is determined by the contact of valve closing body 7 with valve seat surface 29 of valve seat body 16. The other end position of valve needle 5 when magnet coil 10 is excited is determined, for example, by the contact of armature 11 with core 12. The path between these two end positions of valve needle 5 thus represents the lift. Spherical valve closing body 7 interacts with valve seat surface 29 of valve seat body 16, which is conically tapered in the direction of flow, valve seat surface 29 being formed in the axial direction between guide hole 15 and lower outlet opening 31 of valve seat body 16.

Perforated disk 23, which is arranged in outlet opening 31 of valve seat body 16 and held fast by perforated disk carrier 21 on face 17 of valve seat body 16, is illustrated in FIG. 1 only as an example in a simplified form. Instead of the perforated disk 23 depicted, other embodiments of perforated disks having different opening geometries and outer contours can also be attached to a perforated disk carrier 21 designed according to the present invention. Such an indirect attachment of perforated disk 23 on valve seat body 16 has the advantage that deformations caused by temperature, which might occur in operations such as welding or soldering when perforated disk 23 is directly attached, are avoided.

Perforated disks 23 illustrated in FIGS. 1 through 6 are formed by a plurality of metallic functional layers (multilayer electroplating). Due to the deep lithographic electroplating manufacturing, there are special contouring features, some of which are briefly outlined below.

Functional layers having a constant thickness over the disk surface;

slits that are basically perpendicular due to the deep lithographic structuring in the functional layers, forming the hollow spaces through which the fuel flows (deviations of approximately 3° with respect to the optimally perpendicular walls) may occur due to manufacturing tolerances);

desired undercuts and overlaps of the slits due to the multilayer structure of the individual structured metal layers;

slits with any desired cross section shapes having walls that are basically parallel to the axis;

one-piece design of the perforated disk, since the individual metal depositions take place sequentially.

The electroplating steps to produce a perforated disk are described in detail in German Offenlegungsschrift 196 07 288 and form part of the disclosure content here.

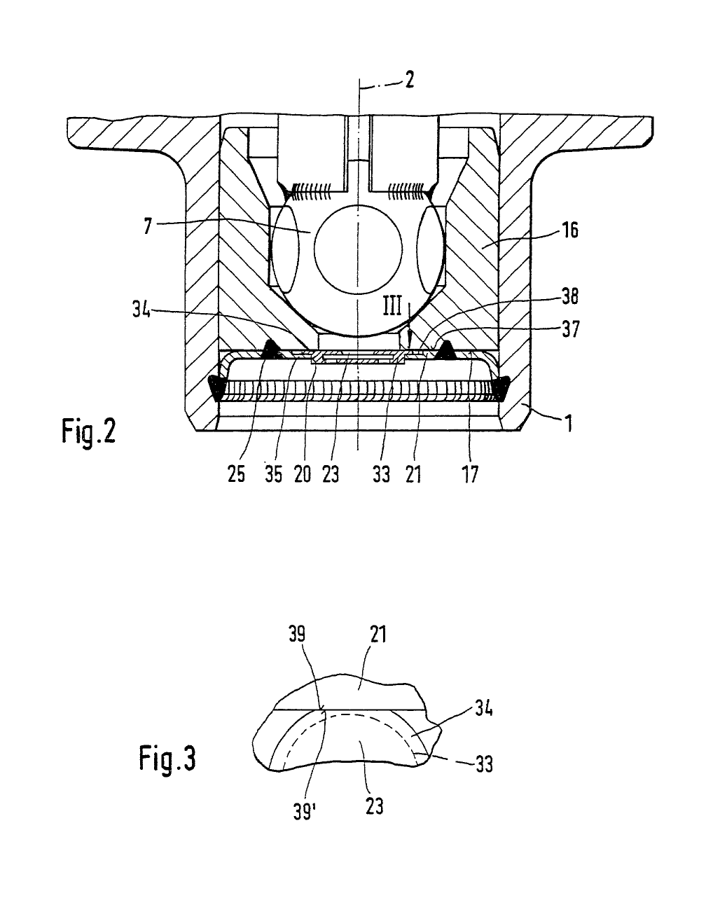

In the other embodiments shown in the following figures, the same parts or parts with the same functions as in the embodiment shown in FIG. 1 are identified with the same reference symbols. FIG. 2 shows a second embodiment of a perforated disk 23 squeezed using a perforated disk carrier 21. Perforated disk 23 is in turn designed as a flat, circular component having a plurality of, for example, three axially sequential functional layers. While the two bottom functional layers formed initially form a perforated disk area 33 with the same outer diameter, the top and last formed functional layer of perforated disk 23 is designed with a greater outer diameter, so that a squeezing region 34 projecting outward is obtained. At least one inlet opening is provided in the top functional layer, while at least one outlet opening is provided in the bottom functional layer; these two openings are connected to one another so that a full axial through passage for the fuel is obtained.

Edge area 35 of perforated disk carrier 21 has a reduced thickness up to through hole 20 in order to achieve the above-described advantages due to the reduced spring constant. In contrast with the first embodiment, edge area 35 has a reduced thickness starting from top face 37 of perforated disk carrier 21, i.e., it is provided with a shoulder 38, which is obtained by stamping, for example. The clearance formed when perforated disk carrier 21 rests on valve seat body 16 in edge area 35 due to the reduced thickness has one axial dimension, for example, which is equal to the axial thickness of the top layer of perforated disk 23 or its squeezing area 34. Thus edge area 35 encloses from below radially projecting squeezing area 34 of perforated disk 23. Bottom area 33 of perforated disk 23, squeezed with a tight fit, snugly extends through hole 20 of perforated disk carrier 21.

Perforated disk 23 is pre-assembled in perforated disk carrier 21 prior to the application of weld 25. Then perforated disk 23 can be fastened precisely in perforated disk carrier 21 by pressing, caulking, crimping or gluing.

FIG. 3 represents a top view of edge area 35, which is secured against turning, of perforated disk 23 in FIG. 2. In order to prevent perforated disk 23 from turning after it is installed and to ensure a specific installed position for the given opening geometry, a simple anti-turning feature can optionally be provided, for example, by applying matching flats 39, 39′ on squeezing area 34 of perforated disk 23 and on perforated disk carrier 21.

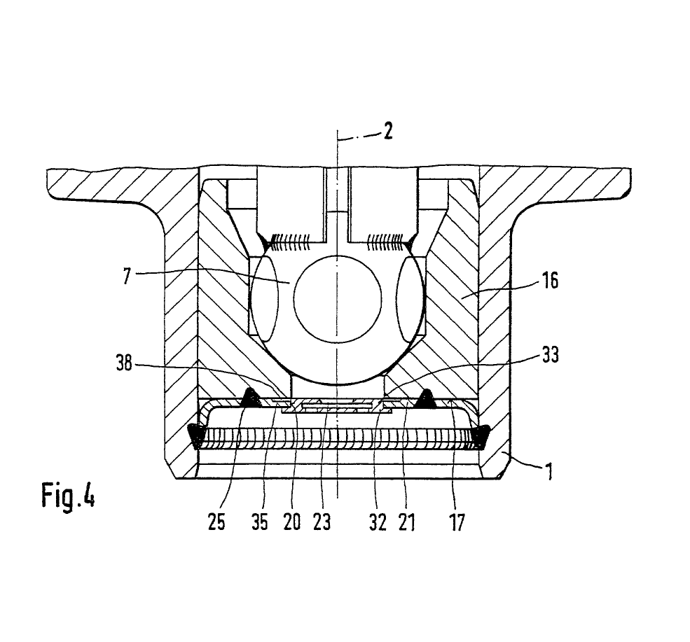

FIG. 4 shows a hybrid form of the previously described embodiments. Perforated disk 23 used in the embodiment of FIG. 4 basically corresponds to that of FIG. 1; perforated disk carrier 21 basically corresponds to that of FIG. 2. Perforated disk area 33, composed of top functional layers of perforated disk 23, projects through opening 20 of perforated disk carrier 21 as in the second embodiment. Bottom base area 32 of perforated disk 23, having a larger outer diameter than perforated disk area 33, encloses edge area 35 of perforated disk carrier 21 from below. Since perforated disk 23 is not squeezed in this embodiment having edge area 35 of perforated disk carrier 21, perforated disk 23 must be secured on perforated disk carrier 21 by pressing, caulking, crimping, or gluing, or even by welding or soldering.

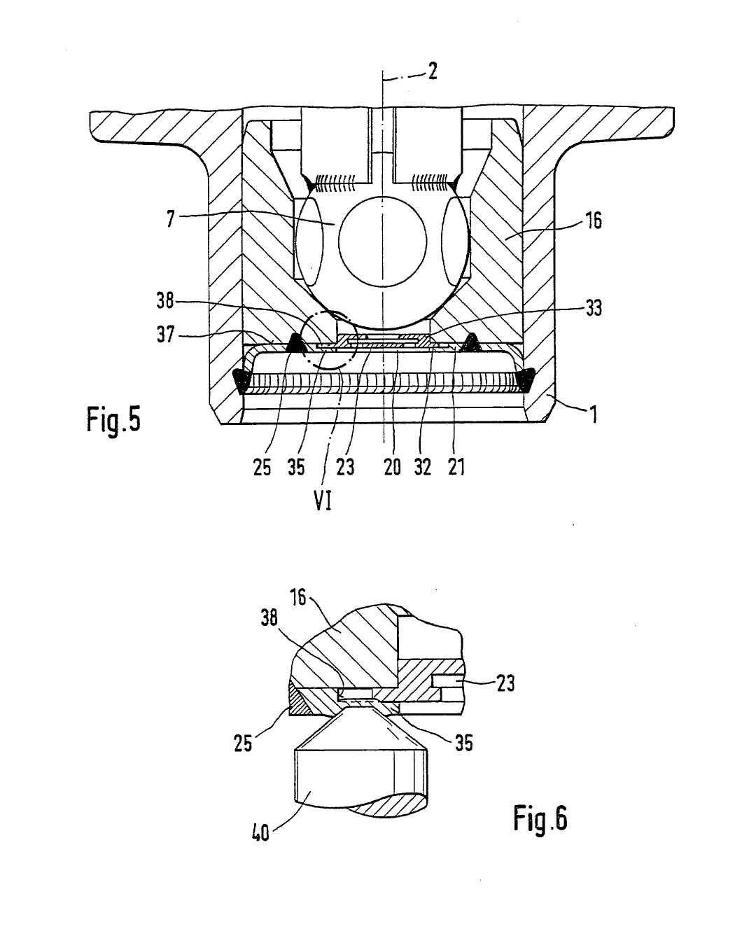

FIG. 5 shows an installation version using perforated disk 23 illustrated in FIG. 1. Top area 33 of perforated disk 23 fits snugly in outlet opening 31 of valve seat body 16. In order to squeeze bottom base area 32 of perforated disk 23 using perforated disk carrier 21, the latter has the same design as in FIG. 2, i.e., a reduced thickness in edge area 35 (shoulder 38) starting from top face 37. The clearance formed due to the reduced thickness in edge area 35 when perforated disk carrier 21 rests on valve seat body 16 has one axial dimension, for example, which corresponds to the axial thickness of the squeezed-in bottom layer of perforated disk 23, i.e., its base area 32.

FIG. 6 shows a section of FIG. 5 with a perforated disk 23 that is secured against turning by caulking. After perforated disk carrier 21 is welded onto valve seat body 16, perforated disk 23 can be secured against turning to ensure a reliable and well-defined position. This can be accomplished by caulking edge area 35 of perforated disk carrier 21 using a punch-shaped tool 40 at one point, for example. In doing this, some material is slightly displaced so that perforated disk 23 is prevented from slipping or turning. Turning can also be prevented by setting a laser point in the area of the caulking shown in FIG. 6, whereby outer base area 32 of perforated disk 23 is secured to perforated disk carrier 21.

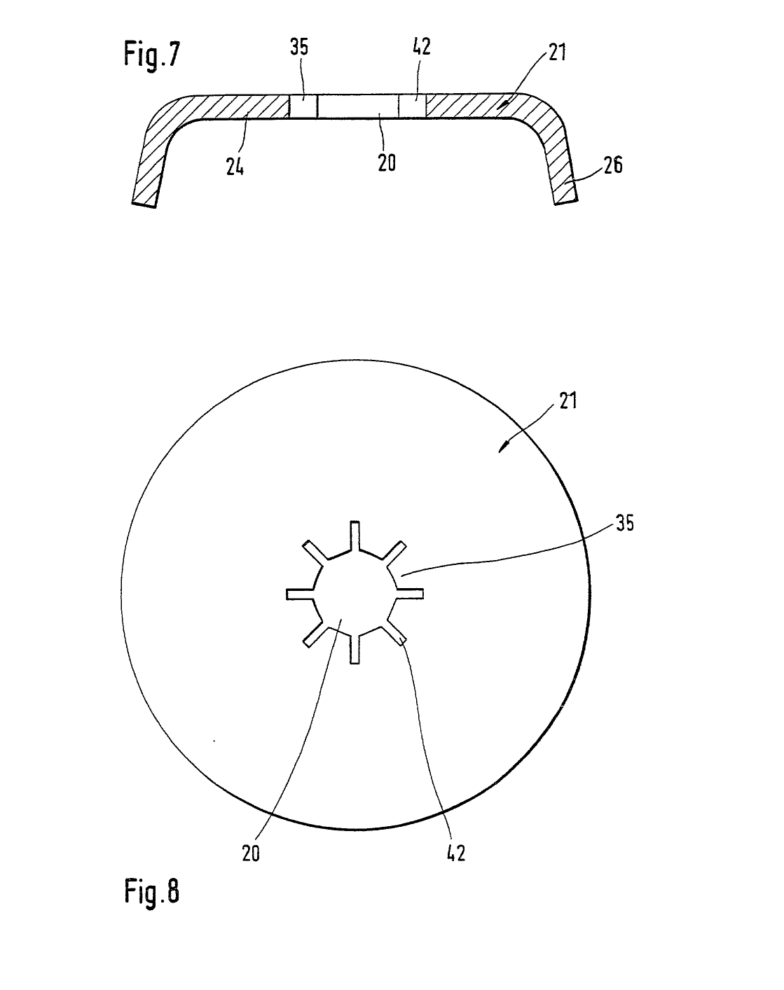

Another embodiment of a perforated disk carrier 21 is shown in FIGS. 7 and 8. Spring constant is reduced, according to the present invention, in edge area 35 of perforated disk carrier 21 not by reducing thickness, but by applying a plurality of radial slots 42. Slots 42 are arranged basically in the shape of a star and are directly connected to through hole 20.

All embodiments of perforated disk carrier 21 can be manufactured by punching, stamping or deformation. The thickness of edge area 35 is reduced by stamping, for example, central through hole 20 being punched out after stamping. As an alternative, through hole 20 can be punched out first and then the punch can be set to stamp edge area 35.

1. A fuel injection valve for fuel injection systems of internal combustion engines, having a longitudinal valve axis; having a valve closing body which interacts with a valve seat surface of a valve seat body; having a perforated disk downstream from the valve seat surface, the perforated disk having a full through passage for a fluid and at least one inlet opening in a top functional layer and at least one outlet opening in a bottom functional layer; and having a disk-shaped perforated disk carrier, which is firmly attached to the valve seat body and through which the perforated disk is held on the valve seat body, and the perforated disk carrier having a through hole, characterized in that the perforated disk carrier (21) is provided with formations that reduce the spring constant of the perforated disk carrier (21) in an edge area (35) surrounding the through hole (20).

2. The fuel injection valve according to claim 1, characterized in that the formation in the edge area (35) is designed as a peripheral shoulder (38).

3. The fuel injection valve according to claim 2, characterized in that the shoulder (38) is made starting from the top face (37) facing the valve seat body (16) of the perforated disk carrier (21).

4. The fuel injection valve according to claim 2, characterized in that the shoulder (38) is made starting from the bottom face (36) facing away the valve seat body (16) of the perforated disk carrier (21).

5. The fuel injection valve according to claim 1, characterized in that the formations in the edge area (35) are designed as a plurality of slots (42) starting from the through opening (20).

6. The fuel injection valve according to claim 5, characterized in that the slots (42) run radially in the form of a star.

7. The fuel injection valve according to one of the foregoing claims, characterized in that the perforated disk (23) has at least two axially consecutive areas (32, 33, 34) having different outer diameters.

8. The fuel injection valve according to claim 7, characterized in that the area (32, 34) of the perforated disk (23) having a larger diameter is squeezed between the edge area (35) of the perforated disk carrier (21) and the valve seat body (16).

9. The fuel injection valve according to claim 7 or 8, characterized in that the area (33) having a smaller diameter of the perforated disk (23) fully traverses the through hole (20) of the perforated disk carrier (21).

10. The fuel injection valve according to one of the foregoing claims, characterized in that the perforated disk (23) is secured against turning in the perforated disk carrier (21).

11. The fuel injection valve according to one of the foregoing claims, characterized in that the perforated disk (23) can be manufactured by multilayer electroplating by forming a plurality of electrodeposited layers.
